(19) United States
(12) Patent Application Publication
(10) Pub. No.: US 2011/0144926 A1
(43) Pub. Date: Jun. 16, 2011

(54) Process for Predicting the Emergence of Longitudinal Cracks During Continuous Casting

(75) Inventors: Dirk Lieftucht, Ledgen (DE); Markus Reiferscheid, Korschenbroich (DE); Matthias Arzberger, Mulheim (DE)

(73) Assignee: SMS Siemag AG, Düsseldorf (DE)

(21) Appl. No.: 12/997,778

(22) PCT Filed: Apr. 30, 2009
(86) PCT No.: PCT/DE2009/000617

§ 371 Date: Feb. 22, 2011

(30) Foreign Application Priority Data
Jun. 13, 2008 (DE) 102008028481.5

(51) Int. Cl. G01N 25/72; G06F 17/18; G06F 19/00

(52) U.S. Cl. 702/35

(57) ABSTRACT

A process for predicting longitudinal cracks during continuous casting of steel slabs. The local strand temperature is measured by thermocouples distributed in the mould wall. In this process, the risk of the strand rupturing as a result of longitudinal cracking is assessed statistically taking into account the current temperature values measured by the thermocouples arranged in the mould and the temperature values determined when no cracks are present.

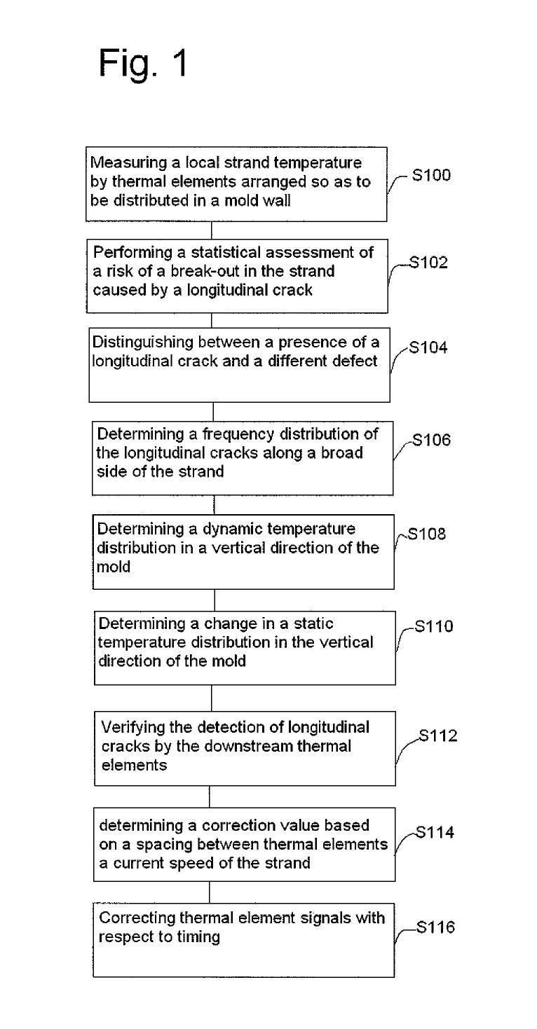

The invention is directed to a method for predicting the occurrence of longitudinal cracks in the continuous casting of steel slabs in which the local strand temperature is measured by thermal elements which are arranged so as to be distributed in the mold wall.

In the continuous casting of steel, longitudinal cracks form in the cooling strand within the mold. Longitudinal cracks can be ascertained by a sharp drop in the temperature of individual thermal elements in the continuous casting mold. A greater predictive accuracy is achieved by means of a plurality of rows of thermal elements distributed along the height of the mold. After the initial detection, the rows of thermal elements which are subsequently passed by the strand can confirm defects and ensure the results. To this end, the thermal element signals in the different rows must be corrected with respect to timing. The correction value is given by the spacing between the rows of thermal elements and the current speed of the strand because the defect is located in a fixed manner in the strand surface.

Previous methods with direct measurement and evaluation of the temperature values such as are described, for example, in JP 01210160 A or JP 62192243 A are often unsuccessful due to the high failure rate of the thermal elements and the poor connection between the tip of the thermal element and the copper of the mold. These connection problems result in signals which are very unreliable with respect to the temperature level.

On the other hand, both of the facts mentioned above give each mold its own “fingerprint” (its own pattern or identifying image). This fingerprint is characterized by deviations in the temperature level and total failures within the high quantity of thermal elements arranged in rows on the broad side and narrow side.

It is the object of the invention to provide a method for predicting the risk of longitudinal cracks.

This object is met according to the invention by a method for predicting the occurrence of longitudinal cracks in the continuous casting of steel slabs in which the local strand temperature is measured by thermal elements which are arranged so as to be distributed in the mold wall in that a statistical assessment of the risk of a break-out in the strand caused by a longitudinal crack is carried out by taking into account the actual temperature values measured by the thermal elements arranged in the mold and based on the temperature values determined in a crack-free state.

Embodiments are indicated in the subclaims and are described in the following.

In contrast to the known method, the invention works with a statistical assessment of the measured temperature values. For this purpose, two method variants can be applied.

The first variant is a model-based method, e.g., principal component analysis (PCA).

By applying a model-based method, actual temperatures are compared to a model and, therefore, information from a preceding casting.

This model is obtained from a historical data set without longitudinal cracks. The model describes the state in which the defect being looked for does not occur. Every PCA alarm is evaluated subsequently by an expert decision system based on fuzzy control, and a decision is made as to whether a longitudinal crack or some other unspecified defect is present. The expert system performs verification of PCA alarms.

This method is based on the two-step process described above.

In this case, the fault detection is carried out by means of a model-based method.

This model-based method compares the actual state of the installation to the normal state which was determined from historical data. An expert system subsequently evaluates the signals of the thermal elements which are arranged one above the other in a column and are passed successively by the longitudinal crack. In so doing, fault identification and fault isolation are carried out. A decision is made on the basis of the temperature gradient as to whether a longitudinal crack or some other kind of defect is present.

In the other method variant, which likewise takes into account the measured temperature values, three risk factors are defined. These risk factors represent the risk of a break-out caused by a longitudinal crack. If one of these factors exceeds a certain magnitude, countermeasures against a break-out caused by a longitudinal crack are taken the next time a longitudinal crack is detected. These countermeasures can consist in reducing the casting speed, influencing the electromagnetic brakes, or specifically changing the set value of the casting surface level.

In particular, the three factors are:

1. Frequency distribution of the longitudinal cracks along the broad side;

2. The distribution of the dynamic temperature distribution in the vertical direction of the mold considered along the broad side; and/or

3. The change in the static temperature distribution in the vertical direction of the mold considered along the broad side.

Underlying all three factors is the fact that large temperature gradients in close proximity can lead to high stresses in the circumferential direction and, therefore, to the bursting of longitudinal cracks.

With respect to the frequency distribution, the percentage of longitudinal cracks occurring at a determined position of the broad side of the mold is calculated. In so doing, the chronological sequence is also taken into account. If the criterion exceeds a determined threshold, countermeasures are introduced as soon as a longitudinal crack occurs at the broad side position of the threshold violation.

The criterion of dynamic temperature distribution in the vertical direction is characterized by the average of the dynamic variation of the thermal elements in a thermal element column. The dynamic variation is mapped, e.g., by the standard deviation or the variance of a measured value over a certain reference time period. If this calculated mean dynamic variation per thermal element column leads to sharply differing values in adjacent columns, countermeasures are adopted. These countermeasures are identical to those in the first criterion. However, the countermeasure only takes effect as soon as another longitudinal crack occurs near the position where the threshold of the second criterion was violated and the threshold of the second criterion is still exceeded when this longitudinal crack occurs.

The third criterion compares the temperature gradient formed from an upper thermal element row minus a lower thermal element row along the broad side of the mold. If the temperature gradients in adjacent columns have sharply differing values, countermeasures identical to those in the first criterion are taken as soon as a longitudinal crack occurs near this specific position and the limiting value of the third criterion is still exceeded when the longitudinal crack occurs.

1. Method for predicting the occurrence of longitudinal cracks in the continuous casting of steel slabs, wherein the local strand temperature is measured by thermal elements which are arranged so as to be distributed in the mold wall, characterized in that a statistical assessment of the risk of a break-out in the strand caused by a longitudinal crack is carried out by taking into account the actual temperature values measured by the thermal elements arranged in the mold and based on the temperature values determined in a crack-free state.

2. Method according to claim 1, characterized in that a statistical assessment is determined from the measurement and evaluation of the thermal elements arranged in rows and columns as a specific fingerprint for the mold.

3. Method according to claims 1 and 2, characterized in that the PCA, or principle component analysis, is applied for the statistical assessment, including data obtained from preceding castings.

4. Method according to claims 1, 2 and 3, characterized in that an expert system downstream of the PCA or principal component analysis distinguishes between the presence of a longitudinal crack or a different defect.

5. Method according to claim 1, characterized in that the following is carried out for the statistical assessment:
a) the frequency distribution of the longitudinal cracks along the broad side of the strand is determined;
b) the dynamic temperature distribution is determined in the vertical direction of the mold along the broad side; and/or
c) the change in the static temperature distribution in the vertical direction of the mold along the broad side is determined.

6. Method according to claim 5, characterized in that the frequency distribution of longitudinal cracks along the broad side of the strand is determined as a percentage and over time.

7. Method according to claim 5, characterized in that the dynamic temperature distribution in the vertical direction of the broad side of the mold is determined by thermal elements which are arranged columnwise so as to be distributed over the height of the mold wall.

8. Method according to claim 5, characterized in that the static temperature distribution along the broad side of the mold is determined by thermal elements which are arranged in rows so as to be distributed over the broad side of the mold.
